(19) United States
(12) Patent Application Publication
(10) Pub. No.: US 2026/0089600 A1
(43) Pub. Date: Mar. 26, 2026

(54) METHODS AND APPARATUSES FOR REDUCING MEASUREMENT ON NEIGHBOUR CELL FREQUENCIES

(71) Applicant: Lenovo (Beijing) Limited, Beijing (CN)

(72) Inventors: Min Xu, Beijing (CN); Ran Yue, Beijing (CN); Lianhai Wu, Beijing (CN); Jing Han, Beijing (CN); Jie Hu, Beijing (CN)

(73) Assignee: Lenovo (Beijing) Limited, Beijing (CN)

(21) Appl. No.: 19/112,858

(22) PCT Filed: Sep. 30, 2022
(86) PCT No.: PCT/CN2022/123297

§ 371 Date: Mar. 18, 2025

(51) Int. Cl. H04W 36/32; H04W 36/00

(52) U.S. Cl. CPC H04W 36/32; H04W 36/0055

(57) ABSTRACT

The present application relates to methods and apparatuses for methods and apparatuses for reducing measurement on neighbour cell frequencies. An embodiment of the present disclosure provides a UE, comprising: a transceiver; and a processor coupled with the transceiver and configured to: receive a message indicating one or more conditions for determining whether to measure on at least one frequency band associated with at least one neighbour cell, wherein the one or more conditions are associated with at least one of the following: at least one coverage parameter of a serving cell; at least one coverage parameter of at least one neighbour cell; or at least one movement parameter of the UE; and measure on the at least one frequency band in the case that neighbour cell measurement is triggered and at least one condition of the one or more conditions is fulfilled; or suspend a triggered neighbour cell measurement in the case that neighbour cell measurement is triggered and no condition of the one or more conditions is fulfilled.

### TECHNICAL FIELD

The present disclosure relates to wireless communication, and particularly relates to methods and apparatuses for reducing measurement on neighbour cell frequencies.

### BACKGROUND OF THE INVENTION

For scenarios of overlapped deployment of non-terrestrial network (NTN) and terrestrial network (TN) with wide difference in cell range, it may not be necessary for all user equipments (UEs) in an NTN cell to measure on all possible neighbour cell frequencies (especially the frequencies of neighbour TN cells) when some neighbour cells may still be far away from the UE.

It is desirable to provide solutions for reducing measurement on terrestrial network (TN) frequencies for NTN-TN mobility.

### SUMMARY

An embodiment of the present disclosure provides a UE, comprising: a transceiver; and a processor coupled with the transceiver and configured to: receive a message indicating one or more conditions for determining whether to measure on at least one frequency band associated with at least one neighbour cell, wherein the one or more conditions are associated with at least one of the following: at least one coverage parameter of a serving cell; at least one coverage parameter of at least one neighbour cell; or at least one movement parameter of the UE; and measure on the at least one frequency band in the case that neighbour cell measurement is triggered and at least one condition of the one or more conditions is fulfilled; or suspend a triggered neighbour cell measurement in the case that neighbour cell measurement is triggered and no condition of the one or more conditions is fulfilled.

In some embodiments, the one or more conditions associated with at least one coverage parameter of a serving cell are associated with one or more of the following: at least one distance threshold; a reference location of a serving cell; at least one latency threshold; at least one elevation angle threshold; at least one horizontal angle threshold; a reference direction of a serving cell; an identity of each beam of at least one beam; an identity of each zone of at least one zone used for sidelink; or at least one validity duration.

In some embodiments, at least one condition of the one or more conditions is fulfilled in response to at least one of the following: a distance between the UE and the reference location being longer than a distance threshold of the at least one distance threshold; a distance between the UE and the reference location being longer than one distance threshold of the at least one distance threshold and shorter than another distance threshold of the at least one distance threshold; a timing advance being longer than a latency threshold of the at least one latency threshold; a timing advance being longer than one latency threshold of the at least one latency threshold and shorter than another latency threshold of the at least one latency threshold; a round-trip time (RTT) between the UE and a serving RAN node being longer than a latency threshold of the at least one latency threshold; a RTT between the UE and a serving RAN node being longer than one latency threshold of the at least one latency threshold and shorter than another latency threshold of the at least one latency threshold; a propagation delay between the UE and a serving RAN node being longer than a latency threshold of the at least one latency threshold; a propagation delay between the UE and a serving RAN node being longer than one latency threshold of the at least one latency threshold and shorter than another latency threshold of the at least one latency threshold; an elevation angle between the UE and a RAN node managing the serving cell being larger than an elevation angle threshold of the at least one elevation angle threshold; an elevation angle between the UE and a RAN node managing the serving cell being larger than one elevation angle threshold of the at least one elevation angle threshold and smaller than another elevation angle threshold of the at least one elevation angle threshold; a horizontal angle between a direction from the UE to the reference location and the reference direction being larger than an horizontal angle threshold of the at least one horizontal angle threshold; a horizontal angle between a direction from the UE to the reference location and the reference direction being larger than one horizontal angle threshold of the at least one horizontal angle threshold and smaller than another horizontal angle threshold of the at least one horizontal angle threshold; a serving beam of the UE being included in the at least one beam; or a current location of the UE being included in the at least one zone.

In some embodiments, the at least one condition of the one or more conditions is fulfilled within the validity duration.

In some embodiments, the one or more conditions associated with at least one coverage parameter of at least one neighbour cell are associated with one or more of the following: at least one distance threshold to a cell reference location of the at least one neighbour cell; at least one distance threshold to an area reference location of the at least one neighbour cell; at least one geographical area; or at least one zone.

In some embodiments, at least one condition of the one or more conditions is fulfilled in response to at least one of the following: a distance between the UE and the cell reference location being shorter than one distance threshold of the at least one distance threshold to a cell reference location; a distance between the UE and the area reference location being shorter than one distance threshold of the at least one distance threshold to an area reference location; a current location of the UE being within the at least one geographical area; or a current location of the UE being within the at least one zone.

In some embodiments, the one or more conditions associated with at least one movement parameter of the UE are associated with at least one time threshold.

In some embodiments, at least one condition of the one or more conditions is fulfilled in response to at least one of the following: a current time being later than a time threshold of the at least one time threshold; or a current time being later than one time threshold of the at least one time threshold and earlier than another time threshold of the at least one time threshold.

In some embodiments, in the case that that neighbour cell measurement is triggered by a distance between the UE of a reference location of the serving cell exceeding a distance threshold, the processor is further configured to: determine whether the one or more conditions being fulfilled based on at least one of the following: a reference location of the serving cell, a location of the UE, or a calculated distance between the serving cell and the UE.

In some embodiments, the processor is further configured to: transmit an indication for requesting one or more updated conditions, at least one updated frequency band, or both.

In some embodiments, in the case that no condition is fulfilled, the processor is further configured to: stay camping on the serving cell.

In some embodiments, in the case that the UE is in CONNECTED state, the processor is further configured to transmit at least one of the following: a reference signal receiving power (RSRP); a reference signal receiving quality (RSRQ); a current location of the UE; a movement of the UE; at least one detected public land mobile network; or at least one neighbour cell.

In some embodiments, the message further indicates at least one of the following: a RSRP variation threshold; a time duration for RSRP variation; a RSRQ variation threshold; a time duration for RSRQ variation; a location variation threshold; or a time duration for location variation.

In some embodiments, the processor is further configured to consider a last evaluation of the one or more conditions as valid and not restart an evaluation on the one or more conditions based on at least one of the following: a variation of RSRP being lower than the RSRP variation threshold; a variation of RSRP being lower than the RSRP variation threshold in the time duration for RSRP variation; a variation of RSRQ being lower than the RSRQ variation threshold; a variation of RSRQ being lower than the RSRQ variation threshold in the time duration for RSRP variation; a variation of location being shorter than the location variation threshold; or a variation of location being shorter than the location variation threshold in the time duration for location variation.

In some embodiments, the processor is further configured to release the one or more conditions in response to at least one of the following: at least one other condition for determining whether to measure on at least one frequency band or not being fulfilled; none of the one or more conditions being fulfilled; a measurement on the at least one frequency band has being performed; or a measurement on the at least one frequency band being triggered due to approaching a stop serving time of the serving cell; or a measurement on the at least one frequency band being triggered after the stop serving time of the serving cell.

In some embodiments, the message includes a system information block or a RRC signaling.

Another embodiment of the present disclosure provides a base station (BS), comprising: a transceiver; and a processor coupled with the transceiver and configured to: determine a message indicating one or more conditions for determining whether to measure on at least one frequency band associated with at least one neighbour cell, wherein the one or more conditions are associated with at least one of the following: at least one coverage parameter of a serving cell; at least one coverage parameter of at least one neighbour cell; or at least one movement parameter of the UE; and transmit the message.

In some embodiments, the one or more conditions associated with at least one coverage parameter of a serving cell are associated with one or more of the following: at least one distance threshold; a reference location of a serving cell; at least one latency threshold; at least one elevation angle threshold; at least one horizontal angle threshold; a reference direction of a serving cell; an identity of each beam of at least one beam; an identity of each zone of at least one zone used for sidelink; or at least one validity duration.

In some embodiments, the one or more conditions associated with at least one coverage parameter of at least one neighbour cell are associated with one or more of the following: at least one distance threshold to a cell reference location of the at least one neighbour cell; at least one distance threshold to an area reference location of the at least one neighbour cell; at least one geographical area; or at least one zone.

In some embodiments, the one or more conditions associated with at least one movement parameter of the UE are associated with at least one time threshold.

In some embodiments, the processor is further configured to: receive an indication for requesting one or more updated conditions, at least one updated frequency band, or both.

In some embodiments, the processor is further configured to receive at least one of the following: a RSRP; a RSRQ; a current location of the UE; a movement of the UE; at least one detected public land mobile network; or at least one neighbour cell.

In some embodiments, the message further indicates at least one of the following: a RSRP variation threshold; a time duration for RSRP variation; a RSRQ variation threshold; a time duration for RSRQ variation; a location variation threshold; or a time duration for location variation.

In some embodiments, the message includes a system information block or a RRC signaling.

Yet another embodiment of the present disclosure provides a method for reducing measurement on a frequency band, comprising: receiving a message indicating one or more conditions for determining whether to measure on at least one frequency band associated with at least one neighbour cell, wherein the one or more conditions are associated with at least one of the following: at least one coverage parameter of a serving cell; at least one coverage parameter of at least one neighbour cell; or at least one movement parameter of the UE; and measuring on the at least one frequency band in the case that neighbour cell measurement is triggered and at least one condition of the one or more conditions is fulfilled; or suspending a triggered neighbour cell measurement in the case that neighbour cell measurement is triggered and no condition of the one or more conditions is fulfilled.

Yet another embodiment of the present disclosure provides a method for reducing measurement on a frequency band, comprising: determining a message indicating one or more conditions for determining whether to measure on at least one frequency band associated with at least one neighbour cell, wherein the one or more conditions are associated with at least one of the following: at least one coverage parameter of a serving cell; at least one coverage parameter of at least one neighbour cell; or at least one movement parameter of the UE; and transmitting the message.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an overlapped deployment of NTN cells and TN cells according to some embodiments of the present disclosure.

FIGS. 2A-2I illustrate conditions for determining whether to measure on at least one frequency band according to some embodiments of the present disclosure.

FIGS. 3A-3C illustrate conditions for determining whether to measure on at least one frequency band according to some embodiments of the present disclosure.

FIG. 4 illustrates illustrate a condition for determining whether to measure on at least one frequency band according to some embodiments of the present disclosure.

FIG. 5 illustrates a method performed by a UE for wireless communication according to some embodiments of the present disclosure.

FIG. 6 illustrates a method performed by a BS for wireless communication according to some embodiments of the present disclosure.

FIG. 7 illustrates a simplified block diagram of an apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as a cellular telephone network, a time division multiple access (TDMA)-based network, a code division multiple access (CDMA)-based network, an orthogonal frequency division multiple access (OFDMA)-based network, a LTE network, a 3^{rd} generation partnership project (3GPP)-based network, LTE, LTE-Advanced (LTE-A), 3GPP 4G, 3GPP 5G NR, 3GPP Release 16 and onwards, a satellite communications network, a high altitude platform network, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

FIG. 1 illustrates an overlapped deployment of NTN cells and TN cells according to some embodiments of the present disclosure.

As shown in FIG. 1, the network includes three UEs, UE1, UE2, and UE3, and two radio access network (RAN) nodes, RAN node #A and RAN node #B. The RAN node may be a satellite, or an unmanned aircraft systems (UAS) platform. Although only three UEs and two satellites/UAS platforms are depicted in FIG. 1, it is contemplated that any number of UEs and satellites/UAS platforms may be included in the wireless communication system.

The UE may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, modems), or the like. According to an embodiment of the present disclosure, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE includes wearable devices, such as smart watches, fitness bands, optical head-mounted displays, or the like. Moreover, the UE may be referred to as subscriber units, mobiles, mobile stations, users, terminals, mobile terminals, wireless terminals, fixed terminals, subscriber stations, user terminals, a device, or by other terminology used in the art. The UE may communicate directly with the satellite BS via service link. The UE may also perform sidelink transmission.

A typical terrestrial communication network includes one or more base stations (typically known as a “BS”) that are located on earth (i.e., not airborne or spaceborne) that each provides geographical radio coverage, and UEs that can transmit and receive data within the radio coverage. In the terrestrial communication network, a BS and a UE can communicate with each other via a communication link, e.g., via a downlink radio frame from the BS to the UE or via an uplink radio frame from the UE to the BS.

The RAN node (e.g. a satellite) may include low earth orbiting (LEO) satellites orbiting around the Earth, medium earth orbiting (MEO) satellites, geostationary earth orbiting (GEO) satellites with fixed location to the Earth, as well as highly elliptical orbiting (HEO) satellites. In accordance with various embodiments, the satellite may be implemented with either a transparent or a regenerative payload. When the satellite carries a transparent payload, it performs only radio frequency filtering, frequency conversion and/or amplification of signals on board. Hence, the waveform signal repeated by the payload is un-changed. When a satellite carries a regenerative payload, in addition to performing radio frequency filtering, frequency conversion and amplification, it performs other signal processing functions such as demodulation/decoding, switching and/or routing, coding/decoding and modulation/demodulation on board as well. In other words, for a satellite with a regenerative payload (all or part of base station functions (e.g., a gNB, eNB, etc.) are implemented on board.

UAS platform(s) may include unmanned aircraft systems (UAS) including tethered UAS and lighter than air UAS (LTA), heavier than air UAS (HTA), and high altitude platforms UAS (HAPs).

Hereinafter in the present disclosure, the RAN node may include: the satellites that carry a transparent payload, satellites that carry a regenerative payload, the UAS platform(s), the BS, or the like.

The wireless communication system as shown in FIG. 1 may be compliant with any type of network that is capable of sending and receiving wireless communication signals. For example, the wireless communication system is compliant with a wireless communication network, a cellular telephone network, a time division multiple access (TDMA)-based network, a code division multiple access (CDMA)-based network, an orthogonal frequency division multiple access (OFDMA)-based network, a LTE network, a 3rd generation partnership project (3GPP)-based network, 3GPP 5G network, a satellite communications network, a high altitude platform network, and/or other communications networks.

In one implementation, the wireless communication system is compliant with the NR of the 3GPP protocol, wherein the BS transmits using an OFDM modulation scheme on the DL and the UE transmits on the UL using a single-carrier frequency division multiple access (SC-FDMA) scheme or OFDM scheme. More generally, however, the wireless communication system may implement some other open or proprietary communication protocol, for example, WiMAX, among other protocols.

In other embodiments, the BS may communicate using other communication protocols, such as the IEEE 802.11 family of wireless communication protocols. Further, in some embodiments the BS may communicate over licensed spectrum, while in other embodiments the BS may communicate over unlicensed spectrum. The present disclosure is not intended to be limited to the implementation of any particular wireless communication system architecture or protocol. In another embodiment, the BS may communicate with the UE using the 3GPP 5G protocols.

Referring to FIG. 1, the RAN node may provide a geographic cell for the UEs located in the geographic cell. For example, RAN node #A may provide service for UEs located in NTN cell #A, and RAN node #B may provide service for UEs located in NTN cell #B. There are also a number of TN cells, TN cell #1, TN cell #2, TN cell #3, and TN cell #4.

Due to the much high altitude of antenna onboard satellites (the maximum height may be 35786 km), an NTN cell may have much larger coverage (e.g. more than 1000 km cell range) than that of a TN cell (e.g. less than 10 km cell range).

In legacy NR or LTE protocols designed for TN, for mobility purposes, the serving cell may broadcast the frequencies of neighbour cells in system information, so that the UE in an IDLE state or an INACTIVE state may search and measure for possible neighbour cells on these frequencies; the serving cell may also indicate the frequencies of neighbour cells in RRC signalling, so that the UE in a CONNECTED state may perform measurement and report to network for a handover procedure. Due to the limited range and consecutive deployment of TN cells, the serving cell usually broadcasts or indicates the frequencies of all possible neighbour cells.

However, in scenarios with overlapped deployment of NTN cells and TN cells, which have wide difference in cell range, it may not be necessary for all UEs in an NTN cell to measure on all possible neighbour cell frequencies (especially the frequencies of neighbour TN cells) when some neighbour cells could still be far away from the UE.

For example, as shown in FIG. 1: UE1 is close to TN cell #1 and TN cell #2, thus may expect to measure on frequencies of TN cell #1 and TN cell #2, and not measure on frequencies of TN cell #3 and TN cell #4. UE2 is close to TN cell #3 and TN cell #4, thus may expect to measure on frequencies of TN cell #3 and TN cell #4, and not measure on frequencies of TN cell #1 and TN cell #2. UE3 is not located near any TN cells, and may not expect to measure on any frequency of TN cells.

In conclusion, the UEs in a NTN cell may not expect to measure on the frequency(s) of one or more TN cells that are not close enough.

However, if the legacy NR or LTE protocols for TN are applied, the RAN node, e.g. RAN node #A, may broadcast all possible frequencies of TN cell #1, TN cell #2, TN cell #3 and TN cell #4 in system information, and the UEs may perform some unnecessary measurements.

In view of the above, for IDLE/INACTIVE state mobility, the present disclosure proposes some solutions for reducing the unnecessary measurements on at least one frequency of a neighbor cell, and the frequency may be used by a TN cell that is far from the UE. These solutions may also be applied to the UE in a CONNECTED state.

Specifically, the present disclosure proposes that the BS may transmit an indication to the UE, to indicate one or more conditions for determining whether to measure on at least one frequency band associated with at least one neighbour cell. The indication may include system information block. Alternatively, the indication may include a RRC signaling, for example, when the UE transits from the CONNECTED state to the IDLE state or INACTIVE state, the BS may transmit a RRC release message to the UE, which may include the indication.

Based on different conditions for determining whether to measure on at least one frequency band associated with at least one neighbour cell (hereinafter referred to as “condition(s)” for simplicity), the solutions are presented as follows:

### Solution 1

In solution 1, the one or more conditions for determining whether to measure on at least one frequency band associated with at least one neighbour cell may be associated with the coverage parameters of the serving cell, e.g. a NTN cell. Specifically, the conditions may include at least one of the following:
1. at least one distance threshold;
2. a reference location of the serving cell, which may be indicated in the indication, in the case that the reference location is not indicated, a default reference location may be used, such as the center of the serving cell;
3. at least one latency threshold;
4. at least one elevation angle threshold;
5. at least one horizontal angle threshold;
6. a reference direction of the serving cell, which may be indicated in the indication, in the case that the reference direction is not indicated, a default or a preconfigured reference location may be used;
7. at least one identity of at least one beam in the serving cell;
8. at least one zone identity used for sidelink; or
9. at least one validity duration of the condition, each of the above parameters in 1-8 may be associated with a validity duration.

After receiving the conditions, and in the case that neighbour cell measurement is triggered at the UE, the UE may evaluate one or more conditions, to determine whether at least one condition is fulfilled or not. In the case that the at least one condition is fulfilled, the UE may measure on at least one frequency band associated with the corresponding condition(s).

The UE may evaluate one or more conditions by the following options:

### Option 1-1: a Condition May Be Associated With at Least One Distance Threshold.

In some embodiments, the condition may be associated with one distance threshold, the UE may determine whether the distance between UE and the reference location of the serving cell is larger than or equal to the distance threshold, or smaller than or equal to the distance threshold. In the case that the distance between UE and the reference location of the serving cell is larger than or equal to the distance threshold, the UE may measure on at least one frequency band associated with the distance threshold. In the case that the distance between UE and the reference location of the serving cell is smaller than or equal to the distance threshold, the UE may not measure on at least one frequency band associated with the distance threshold.

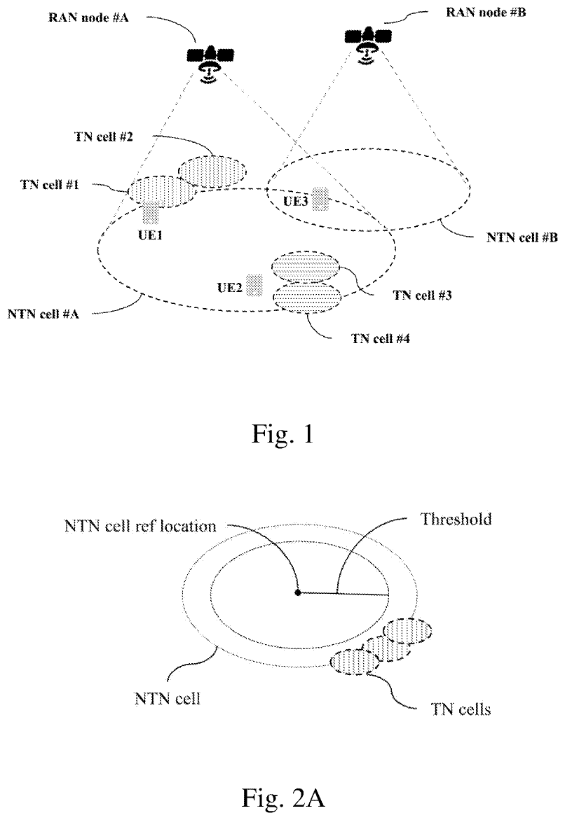

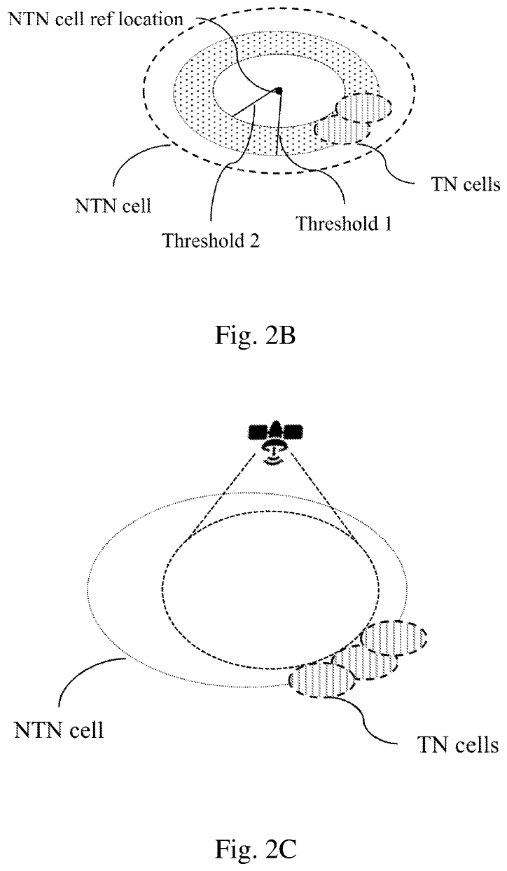

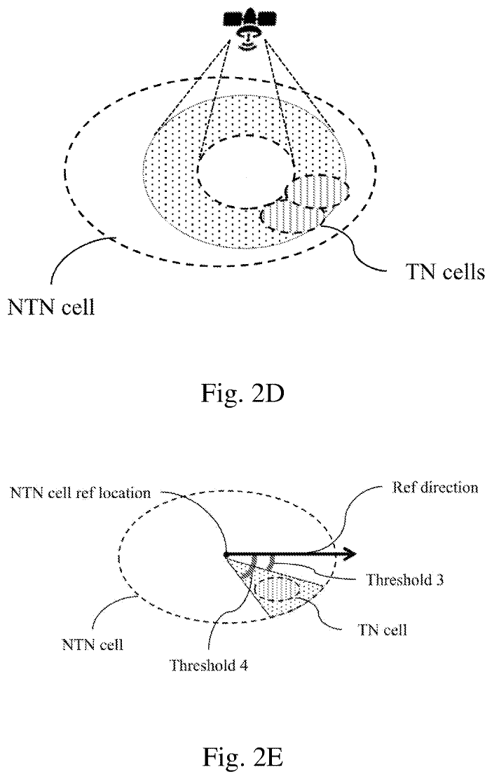

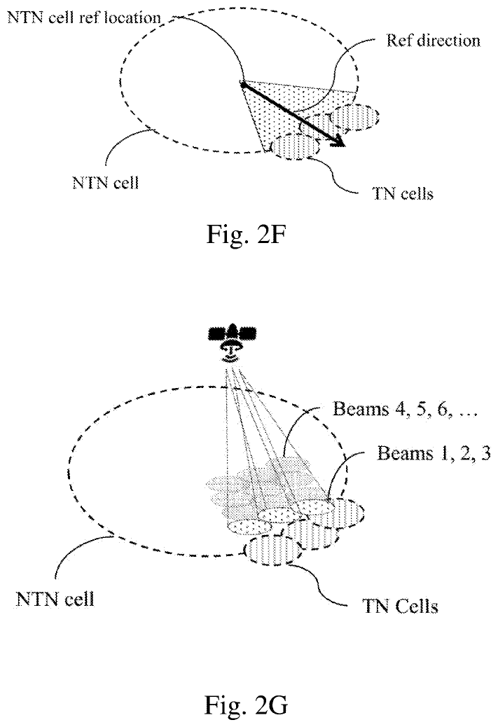

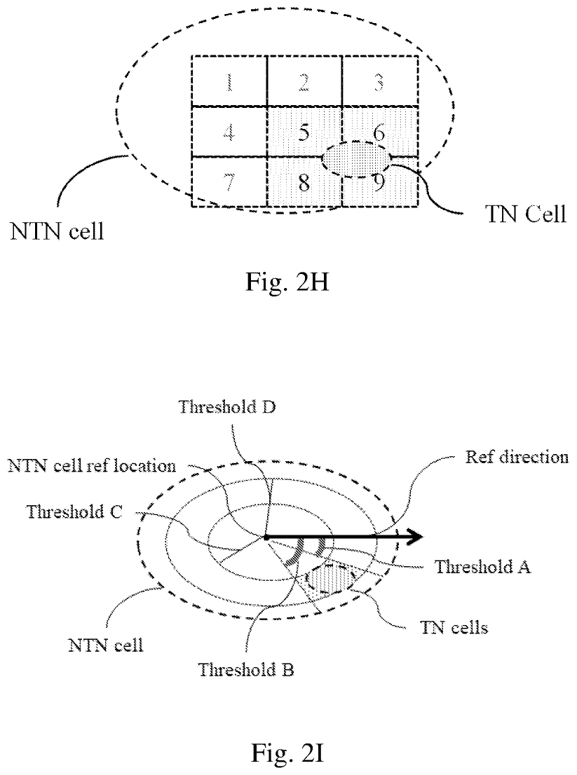

FIG. 2A illustrates a condition for determining whether to measure on at least one frequency band according to some embodiments of the present disclosure.

In FIG. 2A, there is one NTN cell, and three TN cells. The reference location of the serving cell, i.e., “NTN cell ref location,” may be the center of the serving cell, and there is one distance threshold, i.e. “Threshold”. In the case that the distance between UE and the reference location of the serving cell is larger than or equal to the distance threshold, and the UE may measure on the at least one frequency band associated with the distance threshold. In the case that the distance between UE and the reference location of the serving cell is smaller than or equal to the distance threshold (the UE may be located in the inner circle), and the UE may not measure on the at least one frequency band associated with the distance threshold.

In some other embodiments, the condition may be associated with two distance thresholds, the UE may determine the distance between UE and the reference location of the serving cell, and compare the distance with each distance threshold. In the case that the distance between UE and the reference location of the serving cell is between the two distance thresholds (i.e. larger than or equal to one distance threshold and smaller than or equal to the other distance threshold), the UE may measure on the at least one frequency band associated with the two distance thresholds. In the case that the distance is out of the two distance thresholds (i.e. larger than the two distance thresholds, or smaller than the two distance thresholds), the UE may not measure on the at least one frequency band associated with the two distance thresholds.

FIG. 2B illustrates a condition for determining whether to measure on at least one frequency band according to some embodiments of the present disclosure.

In FIG. 2B, there are two distance thresholds, i.e. “Threshold 1” and “Threshold 2.” In the case that the distance between the UE and the reference location (i.e. “NTN cell ref location”) is between the two thresholds, i.e., larger than or equal to threshold 2 and smaller than or equal to threshold 1, the UE may measure on the at least frequency band associated with the two distance thresholds. For example, when the UE is located in the annular area marked by dots, the UE may measure on the at least frequency band associated with the two distance thresholds.

In some embodiments, the condition may be associated with N distance thresholds (N is an integer and N≥3), which may be represented as: D₁, D₂, . . . , D_{N}, wherein D₁<D₂< . . . <D_{N}. The distance between the UE and the reference location, which may be represented as: d, may be in one range of the N+1 different ranges, and the N+1 different ranges may be: d<D₁, D₁≤d<D₂, D₂≤d <D₃, . . . , D_{N}≤d. Each range may be associated with at least one frequency band, or with no frequency band (the UE may not measure on any frequency band), and when the distance between the UE and the reference location is in one range of the N+1 ranges, the UE may perform the corresponding operation associated with the range, which may be measuring on at least one frequency band associated with the range, or not measuring on any frequency band.

### Option 1-2: a Condition May Be Associated With at Least One Latency Threshold.

The UE may determine at least one of the following values:
a timing advance (TA) maintained by the UE;
a UE-specific timing advance derived by the UE;
a RTT between UE and the serving RAN node; or
a propagation delay between UE and the serving RAN node.

The condition may be associated with one latency threshold, the UE may compare the TA maintained by the UE (or the UE-specific TA derived by the UE, the RTT, or the propagation delay) with the latency threshold. In the case that the TA maintained by the UE is larger than or equal to the latency threshold, the UE may measure on at least one frequency band associated with the latency threshold; and in the case that the TA maintained by the UE is smaller than or equal to the latency threshold, the UE may not measure on at least one frequency band associated with the latency threshold.

The condition may be associated with two latency thresholds, the UE may compare the TA maintained by the UE (or the UE-specific TA derived by the UE, the RTT, or the propagation delay) with each latency threshold. In the case that the TA maintained by the UE is between the two latency thresholds (i.e. larger than or equal to one latency threshold and smaller than or equal to the other latency threshold), the UE may measure on the at least one frequency band associated with two latency thresholds. In the case that the TA maintained by the UE is out of the two latency thresholds, the UE may not measure on the at least one frequency band associated with two latency thresholds.

In some embodiments, the condition may be associated with N latency thresholds (N is an integer and N≥3), which may be represented as: L₁, L₂, . . . , L_{N}, wherein L₁<L₂< . . . <L_{N}. The TA maintained by the UE, which may be represented as: l, may be in one range of the N+1 different ranges, and the N+1 different ranges may be: l<L₁, L₁≤l<L₂, L₂≤l<L₃, . . . , L_{N}≤l. Each range may be associated with at least one frequency band, or with no frequency band (the UE may not measure on any frequency band), and when the TA maintained by the UE is in one range of the N+1 ranges, the UE may perform the corresponding operation associated with the range, which may be measuring on at least one frequency band associated with the range, or not measuring on any frequency band.

### Option 1-3: a Condition May Be Associated With at Least One Elevation Angle Threshold.

The condition may be associated with one elevation angle threshold, and the UE may compare the elevation angle between the UE and the RAN node (e.g., a satellite) of the serving cell with the elevation angle threshold. When the elevation angle is larger than or equal to the elevation angle threshold, the UE may measure on at least one frequency band associated with the elevation angle thresholds; and when the elevation angle is smaller than or equal to the elevation angle threshold, the UE may not measure on at least one frequency band associated with the elevation angle threshold.

The condition may be associated with two elevation angle thresholds, and the UE may compare the elevation angle with each elevation angle threshold. When the elevation angle is between the two elevation angle thresholds (i.e. larger than or equal to one elevation angle threshold and smaller than or equal to the other elevation angle threshold), the UE may measure on the at least one frequency band associated with the two elevation angle thresholds. When the elevation angle is out of the two elevation angle thresholds, the UE may not measure on the at least one frequency band associated with the two elevation angle thresholds.

In some embodiments, the condition may be associated with N elevation angle thresholds (N is an integer and N≥3), which may be represented as: E₁, E₂, . . . , E_{N}, wherein E₁<E₂< . . . <E_{N}. The elevation angle between the UE and the RAN node (e.g., a satellite) of the serving cell, which may be represented as: e, may be in one range of the N+1 different ranges, and the N+1 different ranges may be: e<E₁, E₁≤e<E₂, E₂≤e<E₃, . . . , E_{N}≤e. Each range may be associated with at least one frequency band, or with no frequency band (the UE may not measure on any frequency band), and when the elevation angle is in one range of the N+1 ranges, the UE may perform the corresponding operation associated with the range, which may be measuring on at least one frequency band associated with the range, or not measuring on any frequency band.

FIG. 2C illustrates a condition for determining whether to measure on at least one frequency band according to some embodiments of the present disclosure.

In FIG. 2C, there is one NTN cell, and three TN cells, and the condition is associated with one latency threshold. In the case that the TA maintained by the UE (or the UE-specific TA derived by the UE, the RTT, or the propagation delay) is smaller than or equal to the latency threshold, the UE may be located in the inner circle, and may not measure on the at least one frequency band associate with the latency threshold. In the case that the elevation angle between the UE to the RAN node is smaller than the elevation angle threshold, the UE may also be located in the inner circle, and may not measure on the at least one frequency band associate with the latency threshold.

In the case that the TA maintained by the UE (or the UE-specific TA derived by the UE, the RTT, or the propagation delay) is larger than or equal to the latency threshold, the UE may be located outside of the inner circle, and may measure on the at least one frequency band associate with the latency threshold. In the case that the elevation angle between the UE to the RAN node is larger than the elevation angle threshold, the UE may also be located outside of the inner circle, and may not measure on the at least one frequency band associate with the latency threshold.

FIG. 2D illustrates a condition for determining whether to measure on at least one frequency band according to some embodiments of the present disclosure.

In FIG. 2D, there is one NTN cell, and three TN cells, and the condition is associated with two latency thresholds.

In the case that the TA maintained by the UE (or the UE-specific TA derived by the UE, the RTT, or the propagation delay) is between the two latency thresholds (i.e. larger than or equal to one latency threshold and smaller than or equal to the other latency threshold), the UE may be located in the annular area marked by dots, and the UE may measure on the at least frequency band associated with the two latency thresholds. Otherwise, the UE may not measure on the at least frequency band associated with the two latency thresholds.

In the case that the elevation angle between the UE to the RAN node is between the two elevation angle thresholds, the UE may be located in the annular area marked by dots (i.e. larger than or equal to one elevation angle threshold and smaller than or equal to the other elevation angle threshold), and the UE may measure on the at least frequency band associated with the two elevation angle thresholds. Otherwise, the UE may not measure on the at least frequency band associated with the two elevation angle thresholds.

### Option 1-4: a Condition May Be Associated With at Least One Horizontal Angle Threshold.

The condition may be associated with one horizontal angle threshold, and the UE may compare the horizontal angle between a direction from the UE to the reference location of the serving cell with respect to a default direction (or an indicated reference direction) with the horizontal angle threshold.

In the case that the horizontal angle is larger than or equal to the horizontal angle threshold, the UE may measure on at least one frequency band associated with horizontal angle threshold. In the case that the horizontal angle is smaller than or equal to the horizontal angle threshold, the UE may not measure on at least one frequency band associated with horizontal angle threshold.

The condition may be associated with two horizontal angle thresholds, and the UE may compare the horizontal angle between a direction from the UE to the reference location of the serving cell with each horizontal angle threshold. When the horizontal angle is between the two horizontal angle thresholds (i.e. larger than or equal to one horizontal angle threshold and smaller than or equal to the other horizontal angle threshold), the UE may measure on the at least one frequency band. When the horizontal angle is out of the two horizontal angle thresholds, the UE may not measure on the at least one frequency band.

In some embodiments, the condition may be associated with N horizontal angle thresholds (N is an integer and N≥3), which may be represented as: H₁, H₂, . . . , H_{N}, wherein H₁<H₂< . . . <H_{N}. The horizontal angle between a direction from the UE to the reference location of the serving cell with respect to a default direction, which may be represented as: h, may be in one range of the N+1 different ranges, and the N+1 different ranges may be: h<H₁, H₁≤h<H₂, H₂≤h<H₃, . . . , H_{N}≤h. Each range may be associated with at least one frequency band, or with no frequency band (the UE may not measure on any frequency band), and when the horizontal angle is in one range of the N+1 ranges, the UE may perform the corresponding operation associated with the range, which may be measuring on at least one frequency band associated with the range, or not measuring on any frequency band.

FIG. 2E illustrates a condition for determining whether to measure on at least one frequency band according to some embodiments of the present disclosure.

In FIG. 2E, there is one NTN cell, and one TN cell. The reference location of the serving cell, i.e., “NTN cell ref location,” may be the center of the cell, and there is one reference direction, i.e. “Ref direction”.

There are two horizontal angle thresholds, i.e. “Threshold 3” and “Threshold 4.” In the case that the horizontal angle between a direction from the UE to the reference location with respect to the reference direction is within the two thresholds, such as larger than or equal to horizontal angle threshold 3 and smaller than or equal to horizontal angle threshold 4, the UE may be located in the area marked by dots, and may measure on the at least frequency band associated with the two horizontal angle thresholds. In the case that the horizontal angle between a direction from the UE to the reference location with respect to the reference direction is not within the two thresholds, the UE may be located outside of the area marked by dots, and may not measure on the at least frequency band associated with two horizontal angle thresholds.

FIG. 2F illustrates a condition for determining whether to measure on at least one frequency band according to some embodiments of the present disclosure.

FIG. 2F differs from FIG. 2E in the reference direction, in FIG. 2F, the reference direction is not the default direction or a preconfigured direction, it may be indicated in the indication, and the UE may determine the horizontal angle based on the indicated reference direction.

### Option 1-5: a Condition May Be Associated With at Least One Identity of at Least One Beam in the Serving Cell.

The coverage of the NTN network may be associated with a number of beams, and each beam may be associated with an identity. The condition may be associated with at least one identity of at least one beam in the serving cell,

The UE may select one beam in the serving cell, which may be included in the at least one beam, and the UE may measure on the at least frequency band associated with the identity of the selected beam. In the case that the selected beam is not included in the at least one beam, and the UE may not measure on the at least frequency band.

FIG. 2G illustrates a condition for determining whether to measure on at least one frequency band according to some embodiments of the present disclosure.

In FIG. 2G, there is one NTN cell, and three TN cells. A number of beams are included in the NTN coverage, for example, beams 1-3 (the coverage areas of beams 1-3 are the circles marked by dots), beams 4, 5, 6, . . .

The condition may be associated with a number of beams, for example, beam 1, beam 2, and beam 3. In the case that the UE selects any one of beam 1, beam 2, or beam 3, the UE may measure on the at least frequency band associated with the identity of the selected beam. In the case that the UE selects any beam except beam 1, beam 2, or beam 3, such as beam 4, and the UE may not measure on the at least frequency band.

### Option 1-6: a Condition May Be Associated With at Least One Zone Identity Used for Sidelink.

The UE may support sidelink transmission, and a number of zones may be used for sidelink transmission. The NTN coverage may include multiple zones. The condition may be associated with at least one zone.

The UE may be located in one zone, which may be included in the at least one zone, and the UE may measure on the at least frequency band associated with the identity of the located zone. In the case that the located zone is not included in the at least one zone, and the UE may not measure on the at least frequency band associated with the identity of the located zone.

FIG. 2H illustrates a condition for determining whether to measure on at least one frequency band according to some embodiments of the present disclosure.

In FIG. 2H, there is one NTN cell, and one TN cell. A number of zones are included in the NTN coverage, for example, zone 1 to zone 9.

The condition may be associated with a number of zones, for example, zone 5, zone 6, zone 8, and zone 9. In the case that the UE is located in any one of zone 5, zone 6, zone 8, and zone 9, which is associated with the condition, and the UE may measure on the at least frequency band associated with the zone identity. In the case that the UE is located in any one except zone 5, zone 6, zone 8, and zone 9, such as zone 1, and the UE may not measure on the at least frequency band associated with the zone identity.

It should be noted that any of the above conditions may be combined together, for example, the condition may be associated with both the distance thresholds, and horizontal angle thresholds.

FIG. 2I illustrates two conditions for determining whether to measure on at least one frequency band according to some embodiments of the present disclosure.

In FIG. 2I, there are two horizontal angle thresholds (i.e. Threshold A, and Threshold B), and two distance thresholds (i.e. Threshold C, and Threshold D). In the case that the horizontal angle between a direction from the UE to the reference location with respect to a default direction is between the two thresholds (i.e. larger than or equal to Threshold A and smaller than or equal to Threshold B), and the distance between the UE and the reference location is between the two thresholds (i.e. larger than or equal to Threshold C and smaller than or equal to Threshold D), the UE may measure on the at least frequency band associated with four thresholds. As shown in FIG. 2I, the UE may be located in the area marked by dots, and may measure on the at least frequency band associated with the four thresholds. Otherwise, the UE may not measure on the at least frequency band associated with the four thresholds.

In some embodiments, in the case that the reference location of the serving cell is indicated for distance-based neighbour cell measurement triggering, the UE may reuse the reference location of the serving cell for evaluation of the associated condition as well. For example, the UE may use the reference location of the serving cell in option 1-1.

In some embodiments, in the case the neighbour cell measurement is triggered because the distance between the UE and its serving cell reference location (e.g., cell center) is larger than a threshold (e.g. distanceThresh), the UE location or the calculated distance (between the UE and its serving cell reference location) may be reused for evaluation of the associated conditions, without triggering new process of UE location acquiring or distance calculation.

In some embodiments, at least one of the one or more conditions may be associated with a validity duration, when the validity duration expires, the UE may request for updating the frequency band (or the frequency list) and the associated conditions. The validity duration for each condition may be the same, or may be different for different conditions.

In some embodiments, there may be no condition fulfilled, the UE may not measure on any frequency, i.e., the UE may stop neighbour cell measurement for a time duration. The UE may stay camping on the serving cell.

### Solution 2

In solution 2, the one or more conditions for determining whether to measure on at least one frequency band associated with at least one neighbour cell may be associated with the coverage parameters of a neighbour cell, such as a TN cell. Specifically, the conditions may include at least one of the following:
1. at least one distance threshold to a cell reference location of the at least one neighbour cell;
2. at least one distance threshold to an area reference location of the at least one neighbour cell;
3. at least one geographical area; or
4. at least one zone.

After receiving the conditions, and in the case that neighbour cell measurement is triggered at the UE, the UE may evaluate one or more conditions, to determine whether at least one condition is fulfilled or not. In the case that the at least one condition is fulfilled, the UE may measure on at least one frequency band associated with the corresponding condition(s).

The UE may evaluate the one or more conditions by the following options:

### Option 2-1: a Condition May Be Associated With at Least One Distance Threshold to a Cell Reference Location of at Least One Neighbour Cell.

In some embodiment, the condition may be associated with one distance threshold to a cell reference location of the at least one neighbour cell. The UE may determine whether the distance between UE and the reference location of at least one neighbour cell is larger than or equal to the distance threshold, or smaller than or equal to the distance threshold. In the case that the distance between UE and the reference location of the at least one neighbour cell is larger than or equal to the distance threshold, the UE may not measure on at least one frequency band associated with the distance threshold. In the case that the distance between UE and the reference location of the at least one neighbour cell is smaller than or equal to the distance threshold, the UE may measure on at least one frequency band associated with the distance threshold.

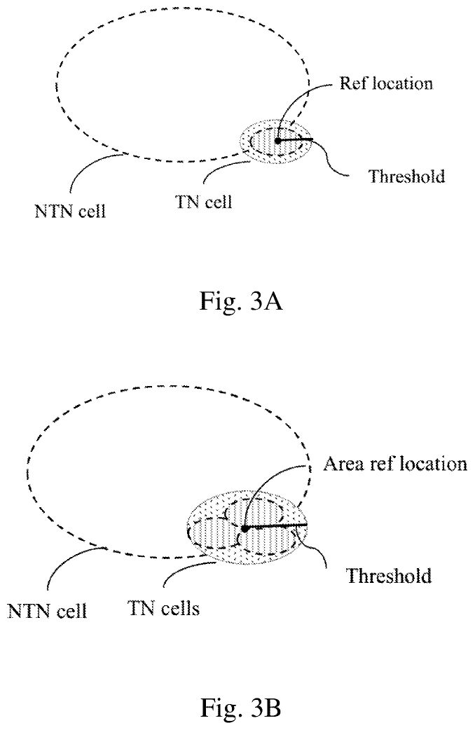

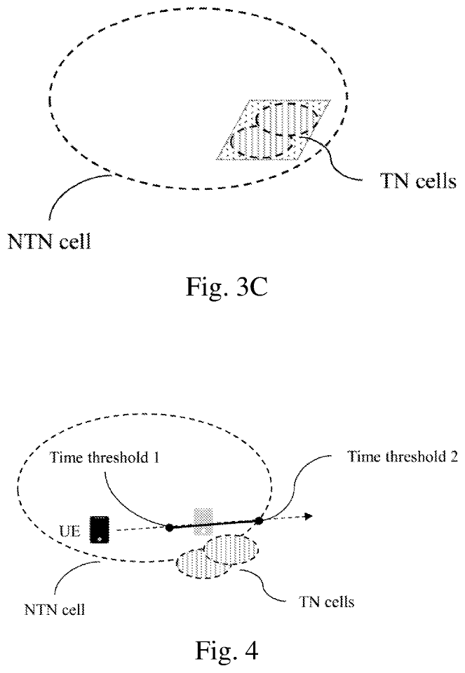

FIG. 3A illustrates a condition for determining whether to measure on at least one frequency band according to some embodiments of the present disclosure.

In FIG. 3A, there is one NTN cell, and one TN cell. The reference location of the TN cell, i.e., “ref location,” may be the center of the neighbour cell, and there is one distance threshold, i.e. “Threshold”. In the case that the distance between UE and the reference location of the TN cell is larger than or equal to the distance threshold, and the UE may not measure on the at least one frequency band associated with the distance threshold. In the case that the distance between UE and the reference location of the TN cell is smaller than or equal to the distance threshold (the UE may be located in the circle marked by dots, the circle may be centered at the reference location and radiused by the value of “threshold”), and the UE may measure on the at least one frequency band associated with the distance threshold.

The condition may be associated with two or more distance thresholds, and the UE may apply similar operations like option 1-1.

### Option 2-2: a Condition May Be Associated With at Least One Distance Threshold to an Area Reference Location of the at Least One Neighbour Cell.

In this option, the reference location is an area reference location of the at least one neighbour cell, or a geographical location. The reference location may not be the center of the at least one neighbour cell. In some embodiments, the area reference location may be indicated without any additional information regarding the area.

The UE may determine whether the distance between UE and the area reference location is larger than or equal to the distance threshold, or smaller than or equal to the distance threshold. In the case that the distance between UE and the area reference location is larger than or equal to the distance threshold, the UE may not measure on at least one frequency band associated with the distance threshold. In the case that the distance between UE and the area reference location is smaller than or equal to the distance threshold, the UE may measure on at least one frequency band associated with the distance threshold.

In some embodiments, the area reference location may be a geographical coordinate in the area.

FIG. 3B illustrates a condition for determining whether to measure on at least one frequency band according to some embodiments of the present disclosure.

In FIG. 3B, there is one NTN cell, and three TN cells. The area reference location of the three TN cells, i.e., “Area ref location,” may be the center of the three TN cells, and there is one distance threshold, i.e. “Threshold”. It should be noted that the area reference location as depicted in FIG. 3B is an example of area reference location, in other embodiments, the area reference location may be any location within the area. In still some other embodiments, the area reference location may be indicated without any additional information regarding the area.

In the case that the distance between UE and the reference location of the three TN cells is larger than or equal to the distance threshold, and the UE may not measure on the at least one frequency band associated with the distance threshold. In the case that the distance between UE and the reference location of the three TN cells is smaller than or equal to the distance threshold (the UE may be located in the circle marked by dots, the circle may be centered at the area reference location and radiused by the value of “threshold”), and the UE may measure on the at least one frequency band associated with the distance threshold.

The condition may be associated with two or more distance thresholds, and the UE may apply similar operations like option 1-1.

### Option 2-3: a Condition May Be Associated With at Least One Geographical Area.

The UE may determine whether the location of the UE is in the at least one geographical area or not. In the case that the location of the UE is in the at least one geographical area, the UE may measure on the at least one frequency band associated with the geographical area. In the case that the location of the UE is not in the at least one geographical area, the UE may not measure on the at least one frequency band associated with the geographical area.

FIG. 3C illustrates a condition for determining whether to measure on at least one frequency band according to some embodiments of the present disclosure.

In FIG. 3C, there is one NTN cell, and two TN cells. There is a geographical area, wherein the two TN cells are also within the geographical area. The information of the geographical area may be indicated, and is associated with at least one frequency band associated with the two TN cells. In the case that the location of the UE is in the geographical area (in the area marked by dots), the UE may measure on the at least one frequency band. In the case that the location of the UE is not in the geographical area, the UE may not measure on the at least one frequency band.

### Option 2-4: the Condition May Be Associated With at Least One Zone Identity Used for Sidelink.

The UE may support sidelink transmission, and a number of zones may be used for sidelink transmission. The TN coverage may include multiple zones. The condition may be associated with at least one identity of at least one zone.

The UE may be located in one zone, which may be included in the at least one zone, and the UE may measure on the at least frequency band associated with the zone identity. In the case that the located zone is not included in the at least one zone, and the UE may not measure on the at least frequency band associated with the TN cells associated with the zone identity.

It should be noted that any of the above conditions may be combined together, for example, the condition may be associated with both the distance thresholds, and at least one identity of at least one geographical area.

In some embodiments, in the case the neighbour cell measurement is triggered because the distance between the UE and its serving cell reference location (e.g., cell center) is larger than a threshold (e.g. distanceThresh), the UE location may be reused for evaluation of the associated conditions, without triggering new process of UE location acquiring. For example, the UE location may be used in option 2-1, 2-2, or 2-3.

In some embodiments, there may be no condition fulfilled, the UE may not measure on any frequency, i.e., the UE may stop neighbour cell measurement for a time duration. The UE may stay camping on the serving cell.

### Solution 3

In solution 3, the network may transmit a dedicated signalling to the UE, which indicates the one or more conditions for determining whether to measure on at least one frequency band associated with at least one neighbour cell. The one or more conditions may be associated with the movement parameter of the UE. Specifically, the one or more conditions may include at least one time threshold.

The network may be aware of the movement parameters of the UE, such as the speed of the movement of the UE, the direction of the movement of the UE, the starting location of the movement of the UE, etc. Based on these movement parameters, the BS may determine at least one time threshold, or at least one time range (each time range may be with two time thresholds), and the UE may measure on at least one frequency band associated with the at least one time threshold, or at least one time range. For example, the BS may be aware of the movement parameters of the UE when the UE is in a CONNECTED state, and when the UE transitions from the connected state to an IDLE state or to an INACTIVE state, the BS may transmit a RRC release message, which indicating the above indication. In some other embodiments, the indication may be included in RRC suspend message.

In some embodiments, the one or more conditions may be associated with one time threshold, and when neighbour cell measurement is triggered, the UE may determine whether the current time is earlier or later than at least one time threshold.

In the case that the current time is earlier than at least one time threshold, the UE may measure on at least one frequency band associated to the time threshold(s). In the case that the current time is later than at least one time threshold, the UE may not measure on at least one frequency band associated to the time threshold(s).

In other embodiments, the one or more conditions may be associated with two time thresholds (i.e. a time range), when neighbour cell measurement is triggered, the UE may determine whether the current time is between the two time thresholds or not.

In the case that the current time is between the two time thresholds, the UE may measure on at least one frequency band associated with the time threshold(s). In the case that the current time is not between the two time thresholds, the UE may not measure on at least one frequency band associated with the time threshold(s).

FIG. 4 illustrates a condition for determining whether to measure on at least one frequency band according to some embodiments of the present disclosure.

In FIG. 4, there is one NTN cell, and two TN cells. The UE may move in the direction indicated by the arrow. Based on the movement information of the UE, when the UE transitions from the RRC connected state to the RRC idle or RRC inactive state, the BS may transmit the RRC signaling, such as RRC release message to the UE, which indicates one or more conditions associated with at least one time threshold, or at least one time range. For example, the condition may be associated with “Time threshold 1” to “Time threshold 2”

In the case that the current time is between the time range from “Time threshold 1” to “Time threshold 2”, the UE may measure on the at least one frequency band associated with the two time thresholds. In the case that the current time is out of the time range, the UE may not measure on the at least one frequency band associated with the two time thresholds.

In some embodiments, the network may configure a CONNECTED UE to report location (and movement), or detected PLMN(s) or neighbour cell(s) before transmitting the RRC release or the RRC suspend message to help determine the associated time threshold or time range.

In some embodiments, the UE may request for updating the frequency band (or the frequency list) and the associated conditions, in the case that the current time is later than any indicated time threshold or time range.

### Solution 4

In some embodiments, the BS may further transmit an indication to the UE, which indicates relaxed evaluation of the one or more conditions for determining whether to measure on at least one frequency band associated with at least one neighbour cell. Specifically, the indication may indicates at least one of the following
1. a RSRP variation threshold;
2. a time duration for RSRP variation;
3. a RSRQ variation threshold;
4. a time duration for RSRQ variation;
5. a location variation threshold; or
6. a time duration for location variation.

In the case that the UE has evaluated on the one or more conditions of measuring or not measuring on at least one frequency band, and the UE may consider a last evaluation of the one or more conditions as valid and not restart an evaluation on the one or more conditions in one of the following cases:
1. a variation of RSRP being lower than the RSRP variation threshold;
   In some embodiments, the variation of RSRP may be determined during a time duration starting from the last evaluation.
2. a variation of RSRP being lower than the RSRP variation threshold in the time duration for RSRP variation;
3. a variation of RSRQ being lower than the RSRQ variation threshold;
   In some embodiments, the variation of RSRQ may be determined during a time duration starting from the last evaluation.
4. a variation of RSRQ being lower than the RSRQ variation threshold in the time duration for RSRP variation;
5. a variation of location being shorter than the location variation threshold;
   In some embodiments, the variation of location may be determined during a time duration starting from the last evaluation; or
6. a variation of location being shorter than the location variation threshold in the time duration for location variation.

### Solution 5

In some embodiments, the UE may maintain (or keep) the one or more conditions as explained in the above solutions 1-3, or release the one or more conditions. In particular, the UE may release the one or more conditions in the following cases:
1. at least one other condition for determining whether to measure on at least one frequency band or not being fulfilled;
2. none of the one or more conditions being fulfilled;
3. a measurement on the at least one frequency band has being performed; or
4. a measurement on the at least one frequency band being triggered due to approaching a stop serving time of the serving cell (e.g. t-Service); or
5. a measurement on the at least one frequency band being triggered after the stop serving time of the serving cell.

Otherwise, the at least one conditions may be maintained at the UE.

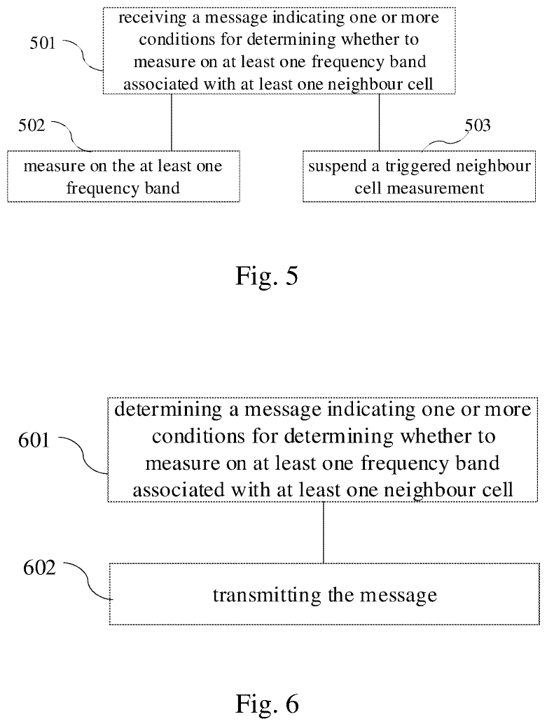

FIG. 5 illustrates a method performed by a UE for wireless communication according to some embodiments of the present disclosure.

In operation 501, the UE may receive a message indicating one or more conditions for determining whether to measure on at least one frequency band associated with at least one neighbour cell, wherein the one or more conditions are associated with at least one of the following: at least one coverage parameter of a serving cell; at least one coverage parameter of at least one neighbour cell; or at least one movement parameter of the UE. In operation 502, measure on the at least one frequency band in the case that neighbour cell measurement is triggered and at least one condition of the one or more conditions is fulfilled. Or in operation 503, the UE may suspend a triggered neighbour cell measurement in the case that neighbour cell measurement is triggered and no condition of the one or more conditions is fulfilled.

In some embodiments, the one or more conditions associated with at least one coverage parameter of a serving cell are associated with one or more of the following: at least one distance threshold; a reference location of a serving cell; at least one latency threshold; at least one elevation angle threshold; at least one horizontal angle threshold; a reference direction of a serving cell; an identity of each beam of at least one beam; an identity of each zone of at least one zone used for sidelink; or at least one validity duration.

In some embodiments, at least one condition of the one or more conditions is fulfilled in response to at least one of the following:
a distance between the UE and the reference location being longer than a distance threshold of the at least one distance threshold (for example, FIG. 2A);
a distance between the UE and the reference location being longer than one distance threshold of the at least one distance threshold and shorter than another distance threshold of the at least one distance threshold (for example, FIG. 2B);
a timing advance being longer than a latency threshold of the at least one latency threshold (for example, FIG. 2C);
a timing advance being longer than one latency threshold of the at least one latency threshold and shorter than another latency threshold of the at least one latency threshold (for example, FIG. 2D);
a round-trip time (RTT) between the UE and a serving RAN node being longer than a latency threshold of the at least one latency threshold (for example, FIG. 2C);
a RTT between the UE and a serving RAN node being longer than one latency threshold of the at least one latency threshold and shorter than another latency threshold of the at least one latency threshold (for example, FIG. 2D);
a propagation delay between the UE and a serving RAN node being longer than a latency threshold of the at least one latency threshold (for example, FIG. 2C);
a propagation delay between the UE and a serving RAN node being longer than one latency threshold of the at least one latency threshold and shorter than another latency threshold of the at least one latency threshold (for example, FIG. 2D);
an elevation angle between the UE and a RAN node managing the serving cell being larger than an elevation angle threshold of the at least one elevation angle threshold (for example, FIG. 2C);
an elevation angle between the UE and a RAN node managing the serving cell being larger than one elevation angle threshold of the at least one elevation angle threshold and smaller than another elevation angle threshold of the at least one elevation angle threshold (for example, FIG. 2D);
a horizontal angle between a direction from the UE to the reference location and the reference direction being larger than an horizontal angle threshold of the at least one horizontal angle threshold;
a horizontal angle between a direction from the UE to the reference location and the reference direction being larger than one horizontal angle threshold of the at least one horizontal angle threshold and smaller than another horizontal angle threshold of the at least one horizontal angle threshold (for example, FIG. 2E and FIG. 2F);
a serving beam of the UE being included in the at least one beam (for example, FIG. 2G); or
a current location of the UE being included in the at least one zone (for example, FIG. 2H).

In some embodiments, the at least one condition of the one or more conditions is fulfilled within the validity duration.

In some embodiments, the one or more conditions associated with at least one coverage parameter of at least one neighbour cell are associated with one or more of the following: at least one distance threshold to a cell reference location of the at least one neighbour cell; at least one distance threshold to an area reference location of the at least one neighbour cell; at least one geographical area; or at least one zone.

In some embodiments, at least one condition of the one or more conditions is fulfilled in response to at least one of the following: a distance between the UE and the cell reference location being shorter than one distance threshold of the at least one distance threshold to a cell reference location (for example, FIG. 3A); a distance between the UE and the area reference location being shorter than one distance threshold of the at least one distance threshold to an area reference location (for example, FIG. 3B); a current location of the UE being within the at least one geographical area (for example, FIG. 2C); or a current location of the UE being within the at least one zone.

In some embodiments, the one or more conditions associated with at least one movement parameter of the UE are associated with at least one time threshold.

In some embodiments, at least one condition of the one or more conditions is fulfilled in response to at least one of the following: a current time being later than a time threshold of the at least one time threshold; or a current time being later than one time threshold of the at least one time threshold and earlier than another time threshold of the at least one time threshold (for example, FIG. 4).

In some embodiments, in the case that that neighbour cell measurement is triggered by a distance between the UE of a reference location of the serving cell exceeding a distance threshold, the UE may determine whether the one or more conditions being fulfilled based on at least one of the following: a reference location of the serving cell, a location of the UE, or a calculated distance between the serving cell and the UE.

In some embodiments, the UE may transmit an indication for requesting one or more updated conditions, at least one updated frequency band, or both.

In some embodiments, in the case that no condition is fulfilled, the UE may stay camping on the serving cell.

In some embodiments, in the case that the UE is in CONNECTED state, the UE may transmit at least one of the following: a reference signal receiving power (RSRP); a reference signal receiving quality (RSRQ); a current location of the UE; a movement of the UE; at least one detected public land mobile network; or at least one neighbour cell.

In some embodiments, the message further indicates at least one of the following: a RSRP variation threshold; a time duration for RSRP variation; a RSRQ variation threshold; a time duration for RSRQ variation; a location variation threshold; or a time duration for location variation.

In some embodiments, the UE may consider a last evaluation of the one or more conditions as valid and not restart an evaluation on the one or more conditions based on at least one of the following: a variation of RSRP being lower than the RSRP variation threshold; a variation of RSRP being lower than the RSRP variation threshold in the time duration for RSRP variation; a variation of RSRQ being lower than the RSRQ variation threshold; a variation of RSRQ being lower than the RSRQ variation threshold in the time duration for RSRP variation; a variation of location being shorter than the location variation threshold; or a variation of location being shorter than the location variation threshold in the time duration for location variation.

In some embodiments, the UE may release the one or more conditions in response to at least one of the following: at least one other condition for determining whether to measure on at least one frequency band or not being fulfilled; none of the one or more conditions being fulfilled; a measurement on the at least one frequency band has being performed; or a measurement on the at least one frequency band being triggered due to approaching a stop serving time of the serving cell; or a measurement on the at least one frequency band being triggered after the stop serving time of the serving cell.

FIG. 6 illustrates a method performed by a BS for wireless communication according to some embodiments of the present disclosure.

In operation 601, the BS may determine a message indicating one or more conditions for determining whether to measure on at least one frequency band associated with at least one neighbour cell, wherein the one or more conditions are associated with at least one of the following: at least one coverage parameter of a serving cell; at least one coverage parameter of at least one neighbour cell; or at least one movement parameter of the UE. In operation 602, the BS may transmit the message.

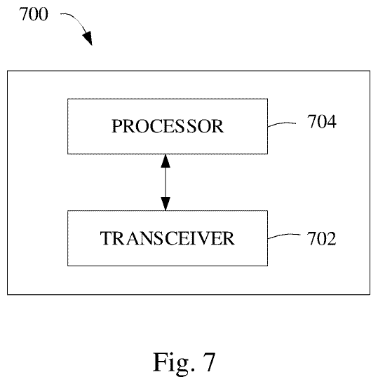

FIG. 7 illustrates a simplified block diagram of an apparatus according to some embodiments of the present disclosure.

As shown in FIG. 7, an example of the apparatus 700 may include at least one processor 704 and at least one transceiver 702 coupled to the processor 704. The apparatus 700 may be a UE, a BS, a RAN node, a source node, a target node, a third node, or any other device with similar functions.

Although in this figure, elements such as the at least one transceiver 702 and processor 704 are described in the singular, the plural is contemplated unless a limitation to the singular is explicitly stated. In some embodiments of the present disclosure, the transceiver 702 may be divided into two devices, such as a receiving circuitry and a transmitting circuitry. In some embodiments of the present disclosure, the apparatus 700 may further include an input device, a memory, and/or other components.

In some embodiments of the present disclosure, the apparatus 700 may be a UE. The transceiver 702 and the processor 704 may interact with each other so as to perform the operations of the UE described in any of FIGS. 1-6. In some embodiments of the present disclosure, the apparatus 700 may be a node. The transceiver 702 and the processor 704 may interact with each other so as to perform the operations of the node described in any of FIGS. 1-6.

In some embodiments of the present disclosure, the apparatus 700 may further include at least one non-transitory computer-readable medium.

For example, in some embodiments of the present disclosure, the non-transitory computer-readable medium may have stored thereon computer-executable instructions to cause the processor 704 to implement the method with respect to the UE as described above. For example, the computer-executable instructions, when executed, cause the processor 704 interacting with transceiver 702 to perform the operations of the UE described in any of FIGS. 1-6.

In some embodiments of the present disclosure, the non-transitory computer-readable medium may have stored thereon computer-executable instructions to cause the processor 704 to implement the method with respect to the node as described above. For example, the computer-executable instructions, when executed, cause the processor 704 interacting with transceiver 702 to perform the operations of the node described in any of FIGS. 1-6.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
receive a message indicating one or more conditions for determining whether to measure on at least one frequency band associated with at least one neighbor cell, wherein the one or more conditions are associated with at least one of:
at least one coverage parameter of a serving cell;
at least one coverage parameter of the at least one neighbor cell; or
at least one movement parameter of the UE; and
measure on the at least one frequency band if a neighbor cell measurement is triggered and at least one condition of the one or more conditions is fulfilled; or
suspend a triggered neighbor cell measurement if the neighbor cell measurement is triggered and no condition of the one or more conditions is fulfilled.

2. The UE of claim 1, wherein the one or more conditions associated with at least one coverage parameter of a serving cell are associated with one or more of:
at least one distance threshold;
a reference location of a serving cell;
at least one latency threshold;
at least one elevation angle threshold;
at least one horizontal angle threshold;
a reference direction of a serving cell;
an identity of each beam of at least one beam;
an identity of each zone of at least one zone used for sidelink; or
at least one validity duration.

3. The UE of claim 2, wherein at least one condition of the one or more conditions is fulfilled in response to at least one of:
a distance between the UE and the reference location being longer than a distance threshold of the at least one distance threshold;
a distance between the UE and the reference location being longer than one distance threshold of the at least one distance threshold and shorter than another distance threshold of the at least one distance threshold;
a timing advance being longer than a latency threshold of the at least one latency threshold;
a timing advance being longer than one latency threshold of the at least one latency threshold and shorter than another latency threshold of the at least one latency threshold;
a round-trip time (RTT) between the UE and a serving radio access network (RAN) node being longer than a latency threshold of the at least one latency threshold;
a RTT between the UE and a serving RAN node being longer than one latency threshold of the at least one latency threshold and shorter than another latency threshold of the at least one latency threshold;
a propagation delay between the UE and a serving RAN node being longer than a latency threshold of the at least one latency threshold;
a propagation delay between the UE and a serving RAN node being longer than one latency threshold of the at least one latency threshold and shorter than another latency threshold of the at least one latency threshold;
an elevation angle between the UE and a RAN node managing the serving cell being larger than an elevation angle threshold of the at least one elevation angle threshold;
an elevation angle between the UE and a RAN node managing the serving cell being larger than one elevation angle threshold of the at least one elevation angle threshold and smaller than another elevation angle threshold of the at least one elevation angle threshold;
a horizontal angle between a direction from the UE to the reference location and the reference direction being larger than an horizontal angle threshold of the at least one horizontal angle threshold;
a horizontal angle between a direction from the UE to the reference location and the reference direction being larger than one horizontal angle threshold of the at least one horizontal angle threshold and smaller than another horizontal angle threshold of the at least one horizontal angle threshold;
a serving beam of the UE being included in the at least one beam; or
a current location of the UE being included in the at least one zone.

4. The UE of claim 3, wherein the at least one condition of the one or more conditions is fulfilled within the validity duration.

5. The UE of claim 1, wherein the one or more conditions associated with at least one coverage parameter of at least one neighbor cell are associated with one or more of:
at least one distance threshold to a cell reference location of the at least one neighbor cell;
at least one distance threshold to an area reference location of the at least one neighbor cell;
at least one geographical area; or
at least one zone.

6. The UE of claim 5, wherein at least one condition of the one or more conditions is fulfilled in response to at least one of:
a distance between the UE and the cell reference location being shorter than one distance threshold of the at least one distance threshold to a cell reference location;
a distance between the UE and the area reference location being shorter than one distance threshold of the at least one distance threshold to an area reference location;
a current location of the UE being within the at least one geographical area; or
a current location of the UE being within the at least one zone.

7. The UE of claim 1, wherein the one or more conditions associated with at least one movement parameter of the UE are associated with at least one time threshold.

8. The UE of claim 7, wherein at least one condition of the one or more conditions is fulfilled in response to at least one of:
a current time being later than a time threshold of the at least one time threshold; or
a current time being later than one time threshold of the at least one time threshold and earlier than another time threshold of the at least one time threshold.

9. The UE of claim 1, wherein the message further indicates at least one of:
a reference signal received power (RSRP) variation threshold;
a time duration for RSRP variation;
a reference signal received quality (RSRQ) variation threshold;
a time duration for RSRQ variation;
a location variation threshold; or
a time duration for location variation.

10. The UE of claim 9, wherein the at least one processor is further configured to cause the UE to consider a last evaluation of the one or more conditions as valid and not restart an evaluation on the one or more conditions based on at least one of:
a variation of RSRP being lower than the RSRP variation threshold;
a variation of RSRP being lower than the RSRP variation threshold in the time duration for RSRP variation;
a variation of RSRQ being lower than the RSRQ variation threshold;
a variation of RSRQ being lower than the RSRQ variation threshold in the time duration for RSRP variation;
a variation of location being shorter than the location variation threshold; or
a variation of location being shorter than the location variation threshold in the time duration for location variation.

11. The UE of claim 1, wherein the at least one processor is further configured to cause the UE to release the one or more conditions in response to at least one of:
at least one other condition for determining whether to measure on at least one frequency band or not being fulfilled;
none of the one or more conditions being fulfilled;
a measurement on the at least one frequency band has being performed; or
a measurement on the at least one frequency band being triggered due to approaching a stop serving time of the serving cell; or
a measurement on the at least one frequency band being triggered after the stop serving time of the serving cell.

12. A base station (BS) for wireless communication, comprising:
at least one memory; and
at least one processor coupled with the at least one memory and configured to cause the BS to:
determine a message indicating one or more conditions for determining whether to measure on at least one frequency band associated with at least one neighbor cell, wherein the one or more conditions are associated with at least one of:
at least one coverage parameter of a serving cell;
at least one coverage parameter of at least one neighbor cell; or
at least one movement parameter of a user equipment (UE); and
transmit the message.

13. The BS of claim 12, wherein the one or more conditions associated with at least one coverage parameter of a serving cell are associated with one or more of:
at least one distance threshold;
a reference location of a serving cell;
at least one latency threshold;
at least one elevation angle threshold;
at least one horizontal angle threshold;
a reference direction of a serving cell;
an identity of each beam of at least one beam;
an identity of each zone of at least one zone used for sidelink; or
at least one validity duration.

14. The BS of claim 12, wherein the one or more conditions associated with at least one coverage parameter of at least one neighbor cell are associated with one or more of:
at least one distance threshold to a cell reference location of the at least one neighbor cell;
at least one distance threshold to an area reference location of the at least one neighbor cell;
at least one geographical area; or
at least one zone.

15. A method performed by a user equipment (UE) for reducing measurement on a frequency band, the method comprising:
receiving a message indicating one or more conditions for determining whether to measure on at least one frequency band associated with at least one neighbor cell, wherein the one or more conditions are associated with at least one of:
at least one coverage parameter of a serving cell;
at least one coverage parameter of at least one neighbor cell; or
at least one movement parameter of the UE; and
measuring on the at least one frequency band if a neighbor cell measurement is triggered and at least one condition of the one or more conditions is fulfilled; or
suspending a triggered neighbor cell measurement if the neighbor cell measurement is triggered and no condition of the one or more conditions is fulfilled.

16. The method of claim 15, wherein the one or more conditions associated with at least one coverage parameter of a serving cell are associated with one or more of:
at least one distance threshold;
a reference location of a serving cell;
at least one latency threshold;
at least one elevation angle threshold;
at least one horizontal angle threshold;
a reference direction of a serving cell;
an identity of each beam of at least one beam;
an identity of each zone of at least one zone used for sidelink; or
at least one validity duration.

17. The method of claim 15, wherein the one or more conditions associated with at least one coverage parameter of at least one neighbor cell are associated with one or more of:
at least one distance threshold to a cell reference location of the at least one neighbor cell;
at least one distance threshold to an area reference location of the at least one neighbor cell;
at least one geographical area; or
at least one zone.

18. The method of claim 17, wherein at least one condition of the one or more conditions is fulfilled in response to at least one of:
a distance between the UE and the cell reference location being shorter than one distance threshold of the at least one distance threshold to a cell reference location;
a distance between the UE and the area reference location being shorter than one distance threshold of the at least one distance threshold to an area reference location;
a current location of the UE being within the at least one geographical area; or
a current location of the UE being within the at least one zone.

19. The method of claim 15, wherein the one or more conditions associated with at least one movement parameter of the UE are associated with at least one time threshold.

20. The method of claim 19, wherein at least one condition of the one or more conditions is fulfilled in response to at least one of:
a current time being later than a time threshold of the at least one time threshold; or
a current time being later than one time threshold of the at least one time threshold and earlier than another time threshold of the at least one time threshold.
